(19) United States
(12) Patent Application Publication
(10) Pub. No.: US 2022/0292535 A1
(43) Pub. Date: Sep. 15, 2022

(54) NEGOTIATION SYSTEM, NEGOTIATION METHOD, AND NEGOTIATION PROGRAM

(71) Applicant: NEC Corporation, Minato-ku, Tokyo (JP)

(72) Inventors: Tomohito ANDO, Tokyo (JP); Shinji NAKADAI, Tokyo (JP); Satoshi MORINAGA, Tokyo (JP)

(73) Assignee: NEC Corporation, Minato-ku, Tokyo (JP)

(21) Appl. No.: 17/631,960

(22) PCT Filed: Aug. 7, 2019
(86) PCT No.: PCT/JP2019/031104

§ 371 Date: Feb. 1, 2022

(51) Int. Cl. G06Q 30/02; G06Q 30/06

(52) U.S. Cl. CPC G06Q 30/0206; G06Q 30/0605

(57) ABSTRACT

A negotiation candidate generation unit 82 generates a negotiation candidate of a receiving side for an assumed order from an ordering side and makes store the negotiation candidate in a negotiation candidate storage unit 81. A negotiation condition receiving unit 83 receives negotiation conditions from the ordering side. A negotiation candidate sending unit 84 sends a corresponding negotiation candidate stored in the negotiation candidate storage unit 81 to the ordering side in response to the received negotiation conditions. The negotiation candidate generation unit 82 includes a planning unit 85 which plans an order plan for execution conditions according to the assumed order from the ordering side, a utility calculation unit 86 which calculates a utility based on the order plan, and a negotiation candidate registration unit 87 which registers the execution conditions, which are a premise of the order plan, as the negotiation candidate in the negotiation candidate storage unit 81, corresponding to the utility calculated based on the order plan. The negotiation candidate sending unit 84 sends the negotiation candidate with the highest utility to the ordering side in priority.

### TECHNICAL FIELD

The present invention relates to a negotiation system, a negotiation method, and a negotiation program for automatically conducting a condition adjustment negotiation between an ordering side and a receiving side.

### BACKGROUND ART

In recent years, an international competition called ANAC (Automated Negotiating Agents Competition) has been held at a prestigious international conference, and expectations for automatic negotiation agent technology are increasing. An automated negotiating agent is a technology that automates negotiations conducted by humans, and uses AI (Artificial Intelligence) to generate draft agreement conditions and determine acceptance or rejection, and various methods for realizing this have been proposed.

Patent literature 1 describes an automatic negotiation system that performs automatic negotiations with other systems. The automatic negotiation system described in patent literature 1 determine target candidates in automatic negotiations from a total result of a demand utility function that represents a change in a profit and loss of a supplier with respect to a change in a demand amount of a consumer from a standard, and a supply utility function represents a change in a profit and loss of a supplier with respect to a change in an aggregate demand amount from a standard.

In addition, patent literature 2 describes a quotation response method that accepts and automatically responds to quotation requests through the Internet or the like. In the method described in patent literature 2, a quotation DB (database) which is a basis of price quotation and a correction DB which can change the setting contents according to the timing of product development requested by the quotation are maintained, and when an opportunity summary and requirement specifications are submitted by a user, a quotation is generated, and a price and a delivery date are corrected for the generated quotation.

### CITATION LIST

### Patent Literature

Patent Literature 1: International Patent Publication No. 2018/070419

Patent Literature 2: Japanese Patent Laid-Open No. 2008-015892

### SUMMARY OF INVENTION

### Technical Problem

On the other hand, when negotiating between the ordering side and the receiving side to adjust conditions such as a delivery date, a quantity, a price, etc., the receiving side needs to judge whether the conditions presented by the ordering side are acceptable based on information such as its own production capacity and production plan. However, the calculations required by the ordering side and the receiving side in making this judgment are asymmetric. Therefore, the calculation cost is not small, and the more complicated the production plan is, the more the amount of calculation.

In the automatic negotiation system described in patent literature 1, the assumed object of negotiation is electric power, and automatic negotiation is performed based on the balance between the predicted demand and supply. However, if the object to be supplied is an object involving a production plan, in order to conduct negotiations, it is necessary to review the production plan, including the already existing production plan, before responding. Since this review of the production plan is an extremely computationally costly task, it is desirable to be able to respond to the conditions proposed by the ordering side as soon as possible, even for such a computationally costly negotiation object.

In addition, patent literature 2 indicates that the load of the development department and the operation status data of the manufacturing line are stored in the quotation DB, and that the delivery date can be obtained. However, obtaining an appropriate delivery date from the load of the development department and the operation status data of the manufacturing line is an extremely computationally costly task, just like the system described in patent literature 1. Therefore, even when performing such an automatic response, it is desired to be able to automatically respond to a quotation request as soon as possible.

Therefore, it is an exemplary object of the present invention to provide a negotiation system, a negotiation method, and a negotiation program capable of responding early to a condition negotiation from an ordering side.

### Solution to Problem

The negotiation system according to the exemplary aspect of the present invention includes a negotiation candidate generation unit which generates a negotiation candidate of a receiving side for an assumed order from an ordering side and makes store the negotiation candidate in a negotiation candidate storage unit, a negotiation condition receiving unit which receives negotiation conditions from the ordering side, and a negotiation candidate sending unit which sends a corresponding negotiation candidate stored in the negotiation candidate storage unit to the ordering side in response to the received negotiation conditions, wherein the negotiation candidate generation unit including a planning unit which plans an order plan for execution conditions according to the assumed order from the ordering side, a utility calculation unit which calculates a utility based on the order plan, and a negotiation candidate registration unit which registers the execution conditions, which are a premise of the order plan, as the negotiation candidate in the negotiation candidate storage unit, corresponding to the utility calculated based on the order plan, wherein the negotiation candidate sending unit which sends the negotiation candidate with the highest utility to the ordering side in priority.

The negotiation method according to the exemplary aspect of the present invention includes planning an order plan for execution conditions according to an assumed order from an ordering side, calculating a utility based on the order plan, registering the execution conditions, which are a premise of the order plan, as a negotiation candidate in a negotiation candidate storage unit, corresponding to the utility calculated based on the order plan, receiving negotiation conditions from the ordering side, sending the negotiation candidate with the highest utility to the ordering side in priority among the negotiation candidates stored in the negotiation candidate storage unit in response to the received negotiation conditions.

The negotiation program according to the exemplary aspect of the present invention causes a computer to execute a negotiation candidate generation process of generating a negotiation candidate of a receiving side for an assumed order from an ordering side and makes store the negotiation candidate in a negotiation candidate storage unit, a negotiation condition receiving process of receiving negotiation conditions from the ordering side, and a negotiation candidate sending process of sending a corresponding negotiation candidate stored in the negotiation candidate storage unit to the ordering side in response to the received negotiation conditions, wherein the negotiation program in the negotiation candidate generation process causes the computer to execute a planning process of planning an order plan for execution conditions according to the assumed order from the ordering side, a utility calculation process of calculating a utility based on the order plan, and a negotiation candidate registration process of registering the execution conditions, which are a premise of the order plan, as the negotiation candidate in the negotiation candidate storage unit, corresponding to the utility calculated based on the order plan, wherein the negotiation program causes the computer to send the negotiation candidate with the highest utility to the ordering side in priority, in the negotiation candidate sending process.

### Advantageous Effects of Invention

According to the exemplary aspect of the present invention, it is possible to respond early to a condition negotiation from an ordering side.

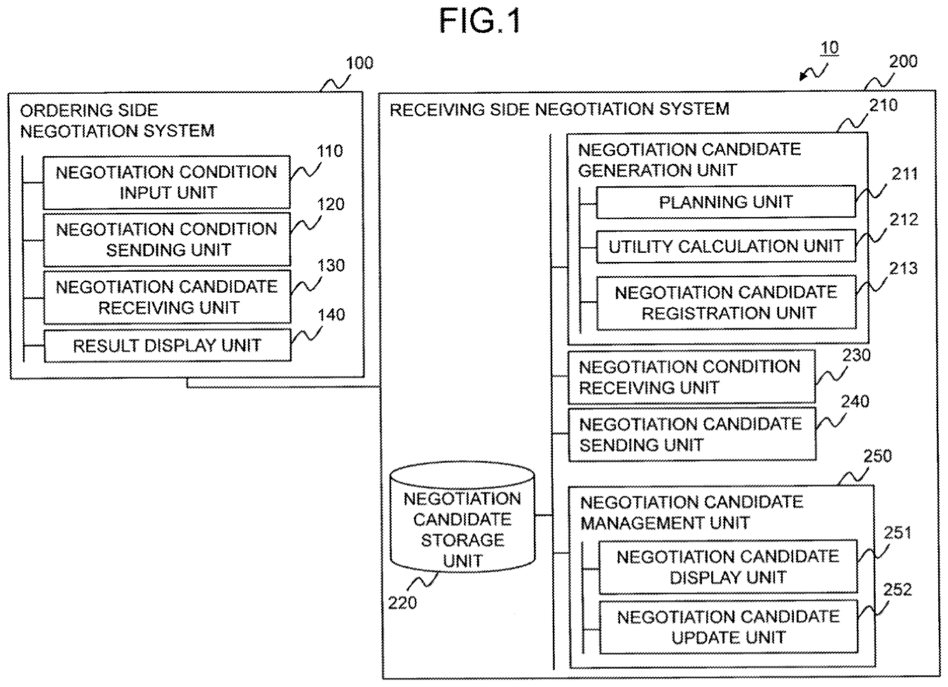

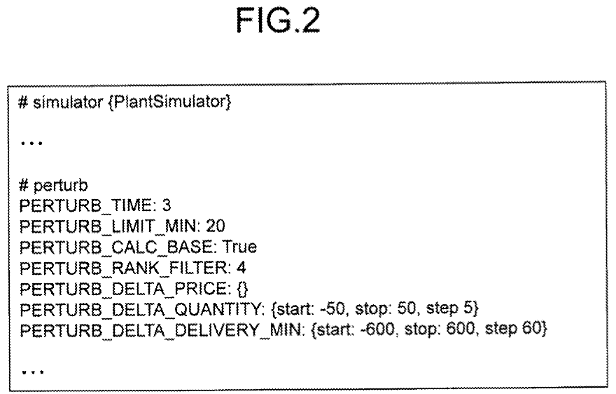

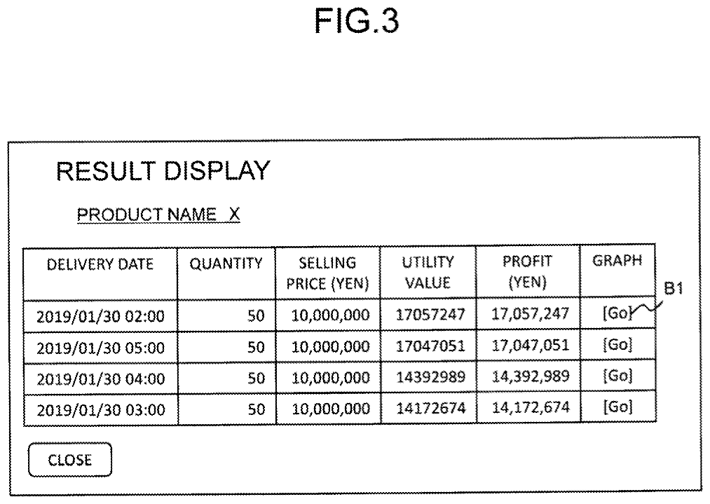

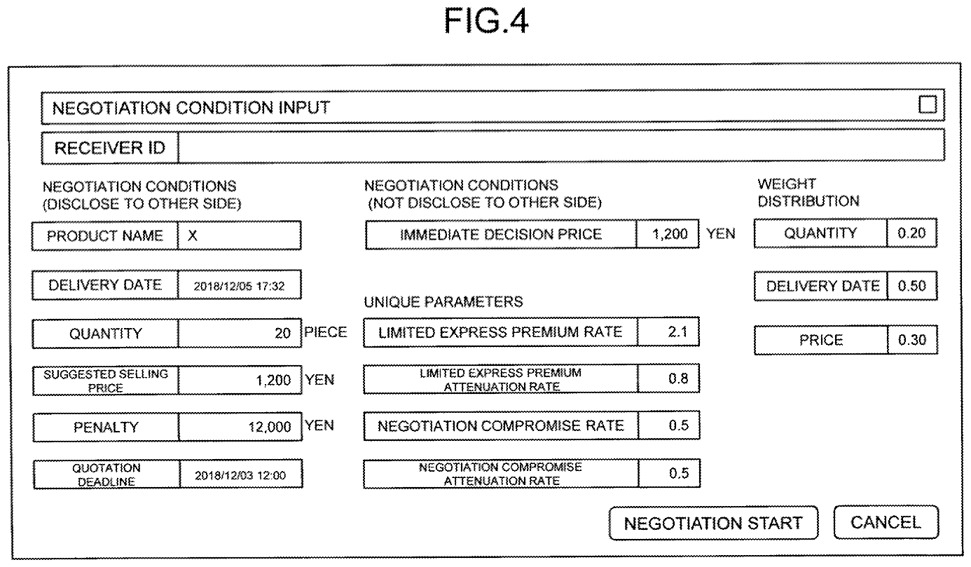

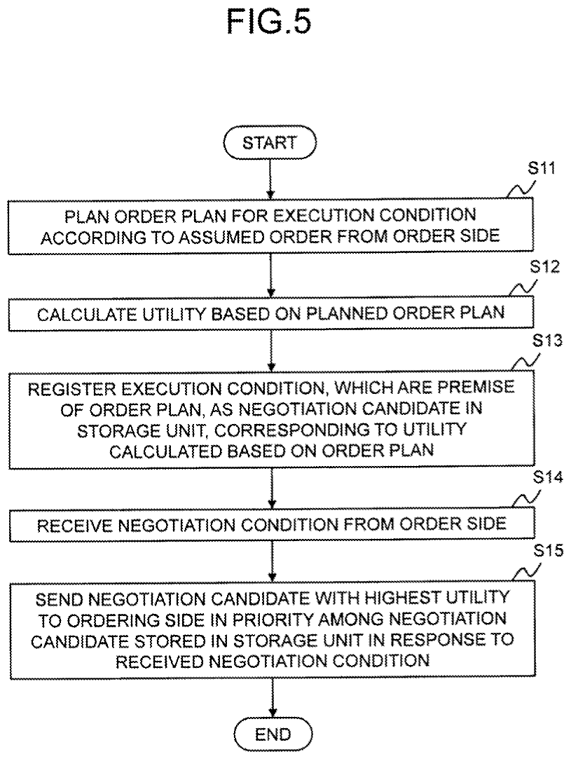

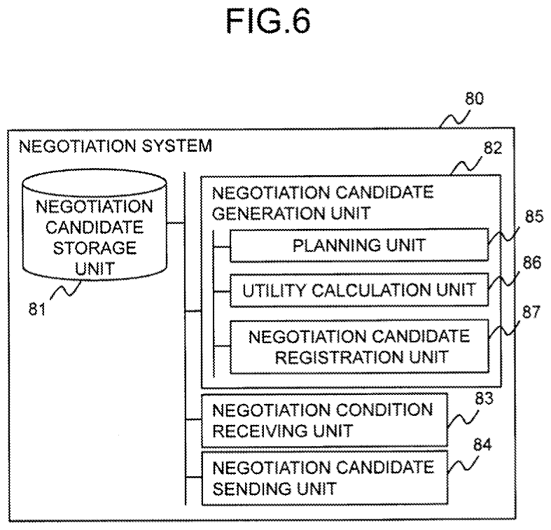

### BRIEF DESCRIPTION OF DRAWINGS

[FIG. 1] It depicts a block diagram showing a configuration example of an exemplary embodiment of a negotiation system according to the present invention.

[FIG. 2] It depicts an explanatory diagram showing an example of a parameter file.

[FIG. 3] It depicts an explanatory diagram showing a display example of negotiation candidates.

[FIG. 4] It depicts an explanatory diagram showing an example of a screen for inputting negotiation conditions.

[FIG. 5] It depicts a flowchart showing an operation example of the automatic negotiation system.

[FIG. 6] It depicts a block diagram showing an overview of a negotiation system according to the present invention.

### DESCRIPTION OF EMBODIMENTS

Hereinafter, each exemplary embodiment of the present invention is described with reference to the drawings.

FIG. 1 is a block diagram showing a configuration example of an exemplary embodiment of a negotiation system according to the present invention. The automatic negotiation system 10 illustrated in FIG. 1 includes an ordering side negotiation system 100 and a receiving side negotiation system 200.

The ordering side negotiation system 100 is a system for an entity that places an order (hereinafter, simply referred to as the ordering side) to negotiate conditions for placing an order with an entity that receives an order (hereinafter, simply referred to as the receiving side). On the other hand, the receiving side negotiation system 200 is a system for presenting negotiation candidates based on the negotiation conditions presented by the ordering side, taking into consideration the conditions for receiving an order and the like. In this exemplary embodiment of the receiving side negotiation system 200, negotiation candidates (negotiation solution candidates) are generated in advance by batch processing at the order side, and negotiations with the order side are conducted based on the negotiation candidates generated in advance at the time of negotiation.

The receiving side negotiation system 200 includes a negotiation candidate generation unit 210, a negotiation candidate storage unit 220, a negotiation condition receiving unit 230, a negotiation candidate sending unit 240, and a negotiation candidate management unit 250.

The negotiation candidate generation unit 210 generates negotiation candidates of the receiving side for the assumed order from the ordering side in advance before receiving the order proposal from the ordering side, and stores them in the negotiation candidate storage unit 220 described below. The assumed order from the ordering side can be defined as a set of conditions representing a demand of the ordering side. The negotiation candidate generation unit 210 includes a planning unit 211, a utility calculation unit 212, and a negotiation candidate registration unit 213.

The planning unit 211 plans an order plan for execution conditions according to an order from the assumed ordering side. The method for determining the assumed order from the ordering side is arbitrary. For example, the planning unit 211 may assume an order from the ordering side based on a past negotiation history. Specifically, the planning unit 211 may determine an order from the assumed ordering side using the history of sales data for each product as the past order history, and using the average value, maximum value, minimum value, and variance value of the sales data, the periodicity of customer's purchase history, etc. Otherwise, the planning unit 211 may, for example, predict that the sales trend of the best-selling product is likely to be repeated. The orders assumed in this manner correspond to the execution conditions required by the ordering side.

Then, the planning unit 211 generates a plurality of execution conditions based on the following method based on the assumed order, and plans an order plan for the generated execution conditions, respectively. The planning unit 211 may, for example, set an interval for each required condition in a parameter file, generate a plurality of execution conditions by varying values in the interval at predetermined intervals, and plan an order plan for each generated execution condition. An order plan for each generated execution condition may be planed. The conditions to be set include a delivery date, a quantity, and a price.

For example, if the number of candidates for which the delivery condition is relaxed (delivery extension) is L, the number of candidates for which the quantity condition is relaxed (quantity reduction) is M, and the number of candidates for which the price condition is relaxed (price increase) is N, the planning unit 211 may generate L×M×N combinations of execution conditions.

FIG. 2 is an explanatory diagram showing an example of a parameter file. The parameter file illustrated in FIG. 2 shows that the initial values and intervals of parameters to be varied (perturbed) are defined. For example, the start and end of the quantity condition (PERTURB_DELTA_QUANTITY) are set to “−50” and “50”, respectively, indicating that the variation interval is 5.

The first method to generate execution conditions is to use beam search. In beam search, the value of an axis that means a condition is varied only once in one search. The axis that can be varied, the maximum width of the value to be varied, and the tick width of the value to be varied can be predetermined according to the contents of the axis (condition).

The second method to generate the execution conditions is to use grid search. Grid search is a method to search for the most highly evaluated pair of parameters by trying all possible combinations of parameters (axes). The method of varying the parameters may be the same as the beam search described above, and the values of multiple axes may be varied simultaneously.

The third method to generate the execution conditions is to the combine beam search and the grid search. In this case, first, the values of axes other than the axis to be varied are fixed, and search is performed by varying only one axis (equivalent to the beam search). After that, the maximum or minimum point is searched, and then the tick width is gradually decreased. Using this method, even if the process is interrupted in the middle, it is possible to generate the execution condition with a certain accuracy.

The fourth method to generate the execution conditions is to probabilistically search for candidates among the execution conditions generated in the past that have not yet been tried. This method can be said that it is a method similar to the Simulated Annealing method and the Genetic Algorithm.

The fifth method to generate the execution conditions is to estimate the bias of the distribution from the history of past execution conditions and to generate detailed candidates according to the bias. This method can be said that it is a method similar to the acquisition function in Bayesian optimization.

The method by which the planning unit 211 plans an order plan for execution conditions is arbitrary. For example, the planning unit 211 may plan the order plan by generating an optimal production schedule by using a mixed integer programming (MIP) problem.

The planning unit 211 may also plan an optimal order plan by manipulating a production model (for example, a factory model) on the simulator using an external script. For example, in the case of optimization by a genetic algorithm, the planning unit 211 may call the optimization module after setting the coefficients of the objective function and the constraint conditions. Also, for example, in the case of performing Bayesian optimization, the planning unit 211 may similarly set the coefficients of the objective function and the constraint conditions, and then call the simulation execution process for obtaining the evaluation values.

When planning an order plan, the planning unit 211 may plan the order plan within the range of resources that can be ordered at this time, or may plan the order plan that includes changes to orders that have already been ordered (existing orders).

In general, the calculation cost for planning an order is high. On the other hand, in the present exemplary embodiment, since the planning unit 211 plans the order plan in advance based on the assumed order from the ordering side, it is not necessary to plan the order plan at the timing when the negotiation is actually conducted. Therefore, it becomes possible to respond early to the condition negotiation from the ordering side.

The utility calculation unit 212 calculates a utility based on the order plan. Specifically, the utility calculation unit 212 calculates the utility using a utility function that calculates the degree of favoritism of the receiving side toward the order plan. The utility function is represented, for example, by Equation 1 illustrated below.

$$\begin{matrix}[ Math . 1 ] & \\ U = \sum {p}_{i} - λ \sum f ( {x}_{i} , {l}_{i} , {d}_{i} ) - \sum {c}_{i} {υ}_{i} - \sum {m}_{j} {d}_{j} - κ ϕ \sum {b}_{k} - θ \sum {h}_{k} - ρ \sum {g}_{i} - \sum {η}_{j} {s}_{j} & ( Equation 1 )\end{matrix}$$

$$\underline{\underline{where}} ↵$$

$$f ( {x}_{i} , {l}_{i} , {d}_{i} ) = \{ \begin{matrix}0 & ( {l}_{i} - {d}_{i} ≦ 0 ) \\ {x}_{i} ( ( {l}_{i} - {d}_{i} ) + log ( 1 + exp ( - ( {l}_{i} - {d}_{i} ) ) ) ) & ( {l}_{i} - {d}_{i} > 0 )\end{matrix}$$

In Equation 1, pᵢ is the price of case i (selling price), and the higher the price, the higher the utility. λ ∈ R⁺ is a hyperparameter, xᵢ is the fine of the case i, lᵢ is the production completion time of the case i, and dᵢ is the delivery date of the case i. In other words, lᵢ−dᵢ denotes the delivery date violation time. This indicates that the utility decreases as the delivery date is exceeded. In addition, cᵢ indicates the direct material cost per product of the case i, and vᵢ indicates the quantity of the case i, and as this value increases, the production cost increases, and the utility decreases.

mⱼ indicates an operating cost per second of a machine j, and tⱼ indicates the total operating time (seconds) of the machine j, and as this value increases, the cost required for operation increases, and the utility decreases. κ is the weight specified by the user, and φ indicates the staying cost per product per second of the buffer, bₖ indicates the average number of staying products per second in buffer k. This is because the more products to be stayed, the higher the cost, and the larger this value, the lower the utility.

In addition, θ indicates the staying cost per maximum staying amount of a buffer, and hₖ indicates the maximum staying amount of a buffer k, and as this value increases, the cost in the buffer increases, and the utility decreases. ρ indicates the cost per second of machine free time, and gⱼ indicates free time (seconds) of machine j, and as this value increases, the utility decreases due to the loss caused by the machine not being in operation. In addition, ηⱼ indicates the start-up cost per day of the machine j, and sⱼ indicates the number of used days of the machine j, and as this value increases, the utility decreases because the cost required to use the machine increases.

Equation 1 above is an example of a utility function, and the content of the function is arbitrary as long as it is a function that can evaluate the desirability of the receiving side to the order plan. For example, a utility function in which only the terms to be considered are selected among the terms included in Equation 1 above may be used.

The negotiation candidate registration unit 213 registers the execution conditions, which is the premise of the order plan, as negotiation candidates in the negotiation candidate storage unit 220 in association with the utility calculated based on the order plan. Since this execution condition is a candidate to be presented in negotiations with the ordering side, it can be called a negotiation candidate. As a result, the execution condition and the utility are associated with each other, so that the utility between the execution conditions can be easily compared.

The negotiation candidate storage unit 220 stores a plurality of negotiation candidates (for example, combinations of execution conditions and utilities). The negotiation candidate storage unit 220 is realized, for example, by a magnetic disk.

The negotiation condition receiving unit 230 receives negotiation conditions of the ordering side from the ordering side negotiation system 100. The negotiation conditions include requests of the ordering side such as a delivery date and a cost. In other words, the negotiation candidate generation unit 210 should generate a negotiation candidate including the requests of the ordering side assumed to be included in the negotiation conditions in the execution conditions.

The negotiation candidate sending unit 240 sends a corresponding negotiation candidate stored in the negotiation candidate storage unit 220 to the ordering side for the received negotiation conditions. For example, when a negotiation candidate based on an execution condition that matches the negotiation condition is stored in the negotiation candidate storage unit 220, the negotiation candidate sending unit 240 may send the negotiation candidate with the highest utility among the negotiation candidates to the ordering side. Alternatively, for example, if no negotiation candidate based on an execution condition that matches the negotiation condition is stored in the negotiation candidate storage unit 220, the negotiation candidate sending unit 240 may send the ordering side a negotiation candidate based on the execution condition that has many matching negotiation conditions, giving priority to the negotiation candidate with the largest utility.

The negotiation candidate management unit 250 manages the negotiation candidates stored in the negotiation candidate storage unit 220. The negotiation candidate management unit 250 has a negotiation candidate display unit 251 and a negotiation candidate update unit 252.

The negotiation candidate display unit 251 displays the negotiation candidates stored in the negotiation candidate storage unit 220. The negotiation candidate display unit 251 may, for example, limit the display to negotiation candidates that correspond to the specified conditions. FIG. 3 is an explanatory diagram showing a display example of negotiation candidates. In the example shown in FIG. 3, the negotiation candidate display unit 251 displays a list in which a delivery date, a quantity, a selling price (yen), a utility value, and a profit (yen) are associated with each other as negotiation candidates for the product whose product name is “X”.

Further, the negotiation candidate display unit 251 may display details of a corresponding order plan for realizing the negotiation candidate. The negotiation candidate display unit 251 may, for example, as illustrated in FIG. 3, comprise a button B1 for instructing a transition to a screen for displaying a graph (for example, a manufacturing line operation plan Gantt chart, etc.) showing an order plan for each negotiation candidate, and may display more detailed information.

The negotiation candidate update unit 252 updates the contents of the negotiation candidates stored in the negotiation candidate storage unit 220. The negotiation candidate update unit 252 may, for example, delete a negotiation candidate that is determined to be inappropriate based on a user's instruction.

The negotiation candidate generation unit 210 (more particularly, the planning unit 211, the utility calculation unit 212 and the negotiation candidate registration unit 213), the negotiation condition receiving unit 230, the negotiation candidate sending unit 240, and the negotiation candidate management unit 250 (more particularly, the negotiation candidate display unit 251 and the negotiation candidate update unit 252) is realized by a computer processor (for example, CPU (Central Processing Unit), GPU (Graphics Processing Unit)) that operates according to a program (negotiation program).

For example, the program is stored in a storage unit (not shown) included in the receiving side negotiation system 200, and the processor reads the program and, according to the program, and may operate as the negotiation candidate generation 210 (more particularly, the planning unit 211, the utility calculation unit 212, and the negotiation candidate registration unit 213), the negotiation condition receiving unit 230, the negotiation candidate sending unit 240 and the negotiation candidate management unit 250 (more particularly, the negotiation candidate display unit 251 and the negotiation candidate update unit 252)). Also, the functions of the receiving side negotiation system 200 may be provided in a SaaS (Software as a Service) format.

The negotiation candidate generation unit 210 (more particularly, the planning unit 211, the utility calculation unit 212 and the negotiation candidate registration unit 213), the negotiation condition receiving unit 230, the negotiation candidate sending unit 240, and the negotiation candidate management unit 250 (more particularly, the negotiation candidate display unit 251 and the negotiation candidate update unit 252) may each be realized by dedicated hardware. In addition, some or all of the components of each of the devices may be realized by general-purpose or dedicated circuitry, processors, or a combination thereof. These may comprise a single chip or a plurality of chips connected through a bus. Some or all of the components of each device may be realized by a combination of the above-described circuits, etc. and a program.

In the case where some or all of each component of the receiving side negotiation system 200 is realized by a plurality of information processing device, circuits, or the like, the plurality of information processing device, circuits, or the like may be centrally arranged or distributed. For example, the information processing device, circuits, and the like may be implemented as a client-server system, a cloud computing system, and the like, each of which is connected through a communication network.

The order side negotiation system 100 includes the negotiation condition input unit 110, the negotiation condition sending unit 120, the negotiation candidate receiving unit 130, and the result display unit 140.

The negotiation condition input unit 110 receives the input of various negotiation conditions from the ordering side. FIG. 4 is an explanatory diagram showing an example of a screen for inputting negotiation conditions. The example shown in FIG. 4 illustrates a screen for inputting negotiation conditions to be disclosed to the other side (the ordering side) and negotiation conditions not to be disclosed to the other side. The negotiation conditions not to be disclosed to the other side are used, for example, when a decision on whether to agree or not to a negotiation candidate presented by the receiving side is automatically made.

The negotiation condition sending unit 120 sends the inputted negotiation conditions to the receiving side negotiation system 200. The negotiation condition sending unit 120 may, for example, limit the send to the negotiation conditions disclosed to the other side among the negotiation conditions illustrated in FIG. 4.

The negotiation candidate receiving unit 130 receives a negotiation candidate for the sent negotiation conditions from the receiving side negotiation system 200. The negotiation candidate receiving unit 130 determines whether or not the negotiation candidate satisfies the predetermined criteria, and if the criteria are satisfied, the negotiation candidate receiving unit 130 may automatically send an agreement to the receiving side negotiation system 200. For example, when the immediate decision price of the negotiation condition illustrated in FIG. 4 is received as a negotiation candidate, the negotiation candidate receiving unit 130 may send a message to the effect that it is an agreement to the receiving side negotiation system 200.

The conditions for determining whether or not agreement is reached are not limited to the price illustrated in FIG. 4. For example, a utility function for calculating the degree of favoritism of the ordering side may be predetermined even on the ordering side, and the negotiation candidate receiving unit 130 may determine that it is an agreement when the utility calculated based on the utility function exceeds a predetermined threshold.

The result display unit 140 displays the contents of the received negotiation candidates. In the case of an automatic negotiation, the result display unit 140 may display the content of the concluded negotiation.

Next, the operation of the negotiation system of this exemplary embodiment will be described. FIG. 5 is a flowchart showing an operation example of the automatic negotiation system 10 (receiving side negotiation system 200) of the present exemplary embodiment.

First, the planning unit 211 of the receiving side negotiation system 200 plans an order plan for execution conditions according to the assumed order from the order side (step S11). The utility calculation unit 212 calculates a utility based on the planned order plan (step S12). The negotiation candidate registration unit 213 registers the execution conditions, which are a premise of the order plan, as a negotiation candidate in the negotiation candidate storage unit 220, corresponding to the utility calculated based on the order plan (step S13).

Thereafter, the negotiation conditions input to the negotiation condition input unit 110 of the ordering side negotiation system 100 are sent by the negotiation condition sending unit 120, and the negotiation condition receiving unit 230 receives the negotiation conditions from the order side (order side negotiation system 100) (step S14). In response to the received negotiation conditions, the negotiation conditions transmitting unit 240 sends the negotiation candidates with the highest utility to the ordering side in priority among the negotiation candidates stored in the negotiation candidate storage unit 220 in response to the received negotiation conditions (step S15). Then, the negotiation candidate receiving unit 130 of the ordering side negotiation system 100 receives the sent negotiation candidates.

As described above, in the present exemplary embodiment, the planning unit 211 plans an order plan for execution conditions corresponding to the assumed order from the ordering side, the utility calculation unit 212 calculates a utility based on the order plan, and the negotiation candidate registration unit 213 registers an execution condition assumed in the order plan as a negotiation candidate in the negotiation candidate storage unit 220 corresponding to the utility calculated based on the order plan. Then, the negotiation condition receiving unit 230 receives the negotiation conditions from the ordering side, and the negotiation candidate sending unit 240 sends the negotiation conditions to the ordering side in priority order from among the negotiation candidates stored in the negotiation candidate storage unit 220. Accordingly, it is possible to respond early to the condition negotiations from the ordering side.

Next, an overview of the present invention will be described. FIG. 6 is a block diagram showing an overview of a negotiation system according to the present invention. A negotiation system (for example, receiving side negotiation system 200) according to the present invention includes a negotiation candidate generation unit 82 (for example, negotiation candidate generation unit 210) which generates a negotiation candidate of a receiving side for an assumed order from an ordering side (for example, ordering side negotiation system 100) and makes store the negotiation candidate in a negotiation candidate storage unit 81 (for example, negotiation candidate storage unit 220), a negotiation condition receiving unit 83 (for example, negotiation condition receiving unit 230) which receives negotiation conditions from the ordering side, and a negotiation candidate sending unit 84 (for example, negotiation candidate sending unit 240) which sends a corresponding negotiation candidate stored in the negotiation candidate storage unit 81 to the ordering side in response to the received negotiation conditions.

The negotiation candidate generation unit 82 includes a planning unit 85 (for example, planning unit 211) which plans an order plan for execution conditions according to the assumed order from the ordering side, a utility calculation unit 86 (for example, utility calculation unit 212) which calculates a utility based on the order plan, and a negotiation candidate registration unit 87 (for example, negotiation candidate registration unit 213) which registers the execution conditions, which are a premise of the order plan, as the negotiation candidate in the negotiation candidate storage unit 81, corresponding to the utility calculated based on the order plan.

The negotiation candidate sending unit 84 sends the negotiation candidate with the highest utility to the ordering side in priority.

With such a configuration, it is possible to respond early to a condition negotiation from an ordering side.

The planning unit 85 may generate a plurality of execution conditions based on the assumed order, and plan the order plans for the generated execution conditions, respectively.

Further, the planning unit 85 may generate a plurality of execution conditions by varying the values in the interval for each required condition at predetermined intervals, and plan the order plan for each generated execution condition.

The utility calculation unit 86 may calculate the utility using a utility function (for example, Equation 1 described above) that calculates the degree of favoritism of the receiving side toward the order plan.

The negotiation candidate sending unit 84 may sends to the ordering side the negotiation candidate with the highest utility among the negotiation candidates based on the execution conditions that match the negotiation conditions.

The planning unit 85 may determine the assumed order based on an order history (for example, sales data for each product) from the ordering side in the past.

The planning unit 85 may plan optimal order plan by processing using a simulator with an optimization engine.

Specifically, the execution conditions may include a delivery date, a quantity and a price.

A part of or all of the above exemplary embodiments may also be described as, but not limited to, the following supplementary notes.

(Supplementary note 1) A negotiation system comprising:

a negotiation candidate generation unit which generates a negotiation candidate of a receiving side for an assumed order from an ordering side and makes store the negotiation candidate in a negotiation candidate storage unit;

a negotiation condition receiving unit which receives negotiation conditions from the ordering side; and

a negotiation candidate sending unit which sends a corresponding negotiation candidate stored in the negotiation candidate storage unit to the ordering side in response to the received negotiation conditions, wherein

the negotiation candidate generation unit including:

a planning unit which plans an order plan for execution conditions according to the assumed order from the ordering side;

a utility calculation unit which calculates a utility based on the order plan; and

a negotiation candidate registration unit which registers the execution conditions, which are a premise of the order plan, as the negotiation candidate in the negotiation candidate storage unit, corresponding to the utility calculated based on the order plan, wherein

the negotiation candidate sending unit which sends the negotiation candidate with the highest utility to the ordering side in priority.

(Supplementary note 2) The negotiation system according to Supplementary note 1, wherein

the planning unit generates a plurality of execution conditions based on the assumed order, and plans the order plans for the generated execution conditions, respectively.

(Supplementary note 3) The negotiation system according to Supplementary note 1 or 2, wherein

the planning unit generates a plurality of execution conditions by varying the values in the interval for each required condition at predetermined intervals, and plans the order plan for each generated execution condition.

(Supplementary note 4) The negotiation system according to any one of Supplementary notes 1 to 3, wherein

the utility calculation unit calculates the utility using a utility function that calculates the degree of favoritism of the receiving side toward the order plan.

(Supplementary note 5) The negotiation system according to any one of Supplementary notes 1 to 4, wherein

the negotiation candidate sending unit sends to the ordering side the negotiation candidate with the highest utility among the negotiation candidates based on the execution conditions that match the negotiation conditions.

(Supplementary note 6) The negotiation system according to any one of Supplementary notes 1 to 5, wherein

the planning unit determines the assumed order based on an order history from the ordering side in the past.

(Supplementary note 7) The negotiation system according to any one of Supplementary notes 1 to 6, wherein

the planning unit plans an optimal order plan by processing using a simulator with an optimization engine.

(Supplementary note 8) The negotiation system according to any one of Supplementary notes 1 to 7, wherein

the execution conditions include a delivery date, a quantity and a price.

(Supplementary note 9) A negotiation method comprising:

planning an order plan for execution conditions according to an assumed order from an ordering side;

calculating a utility based on the order plan;

registering the execution conditions, which are a premise of the order plan, as a negotiation candidate in a negotiation candidate storage unit, corresponding to the utility calculated based on the order plan;

receiving negotiation conditions from the ordering side; and

sending the negotiation candidate with the highest utility to the ordering side in priority among the negotiation candidates stored in the negotiation candidate storage unit in response to the received negotiation conditions.

(Supplementary note 10) The negotiation method according to Supplementary note 9, wherein

generating a plurality of execution conditions based on the assumed order, and plans the order plans for the generated execution conditions, respectively.

(Supplementary note 11) A negotiation program causing a computer to execute:

a negotiation candidate generation process of generating a negotiation candidate of a receiving side for an assumed order from an ordering side and makes store the negotiation candidate in a negotiation candidate storage unit;

a negotiation condition receiving process of receiving negotiation conditions from the ordering side; and

a negotiation candidate sending process of sending a corresponding negotiation candidate stored in the negotiation candidate storage unit to the ordering side in response to the received negotiation conditions,

wherein the negotiation program in the negotiation candidate generation process causes the computer to execute:

a planning process of planning an order plan for execution conditions according to the assumed order from the ordering side;

a utility calculation process of calculating a utility based on the order plan; and

a negotiation candidate registration process of registering the execution conditions, which are a premise of the order plan, as the negotiation candidate in the negotiation candidate storage unit, corresponding to the utility calculated based on the order plan,

wherein the negotiation program causes the computer to send the negotiation candidate with the highest utility to the ordering side in priority, in the negotiation candidate sending process.

(Supplementary note 12) The negotiation program according to Supplementary note 11 causing the computer to execute

generating a plurality of execution conditions based on the assumed order, and planning the order plans for the generated execution conditions, respectively, in the planning process.

### REFERENCE SIGNS LIST

10 Negotiation system

100 Ordering side negotiation system

110 Negotiation condition input unit

120 Negotiation condition sending unit

130 Negotiation candidate receiving unit

140 Result display unit

200 Receiving side negotiation system

210 Negotiation candidate generation unit

211 Planning unit

212 Utility calculation unit

213 Negotiation candidate registration unit

220 Negotiation candidate storage unit

230 Negotiation condition receiving unit

240 Negotiation candidate sending unit

250 Negotiation candidate management unit

251 Negotiation candidate display unit

252 Negotiation candidate update unit

What is claimed is:

1. A negotiation system comprising:
a memory storing instructions; and
one or more processors configured to execute the instructions to:
plan at least one of order plans for each of execution conditions according to an assumed order from an ordering side;
calculate at least one of utilities based on the order plan;
register the execution conditions, which are a premise of the order plan, as a negotiation candidate in a negotiation candidate storage unit, corresponding to the utility calculated based on the order plan;
receive negotiation conditions from the ordering side; and
send the negotiation candidate with the highest utility to the ordering side in priority among the negotiation candidates stored in the negotiation candidate storage unit in response to the received negotiation conditions.

2. (canceled)

3. The negotiation system according to claim 1, wherein the processor further executes instructions to generate a plurality of execution conditions by varying the values in the interval for each required condition at predetermined intervals, and plan the order plan for each generated execution condition.

4. The negotiation system according to claim 1, wherein the processor further executes instructions to calculate the utility using a utility function that calculates the degree of favoritism of the receiving side toward the order plan.

5. The negotiation system according to claim 1, wherein the processor further executes instructions to send to the ordering side the negotiation candidate with the highest utility among the negotiation candidates based on the execution conditions that match the negotiation conditions.

6. The negotiation system according to claim 1, wherein the processor further executes instructions to determine the assumed order based on an order history from the ordering side in the past.

7. The negotiation system according to claim 1, wherein the processor further executes instructions to plan an optimal order plan by processing using a simulator with an optimization engine.

8. The negotiation system according to claim 1, wherein
the execution conditions include a delivery date, a quantity and a price.

9. A negotiation method comprising:
planning at least one of order plans for each of execution conditions according to an assumed order from an ordering side;
calculating at least one of utilities based on the order plan;
registering the execution conditions, which are a premise of the order plan, as a negotiation candidate in a negotiation candidate storage unit, corresponding to the utility calculated based on the order plan;
receiving negotiation conditions from the ordering side; and
sending the negotiation candidate with the highest utility to the ordering side in priority among the negotiation candidates stored in the negotiation candidate storage unit in response to the received negotiation conditions.

10. (canceled)

11. A non-transitory computer readable information recording medium storing a negotiation program, when executed by a processor, that performs a method for:
planning at least one of order plans for each of execution conditions according to an assumed order from an ordering side;
calculating at least one of utilities based on the order plan;
registering the execution conditions, which are a premise of the order plan, as a negotiation candidate in a negotiation candidate storage unit, corresponding to the utility calculated based on the order plan;
receiving negotiation conditions from the ordering side; and
sending the negotiation candidate with the highest utility to the ordering side in priority among the negotiation candidates stored in the negotiation candidate storage unit in response to the received negotiation conditions.

12. (canceled)
